(19) United States
(12) Patent Application Publication
(10) Pub. No.: US 2026/0134000 A1
(43) Pub. Date: May 14, 2026

(54) METHODS AND SYSTEMS FOR GRAPH ABSTRACTION

(71) Applicant: Netflix, Inc., Los Gatos, CA (US)

(72) Inventors: Rajiv Shringi, Fremont, CA (US); Oleksii Tkachuk, Snohomish, WA (US); Kartik Sathyanarayanan, Campbell, CA (US); Christopher Van Vlack, Madison, WI (US)

(21) Appl. No.: 19/306,181

(22) Filed: Aug. 21, 2025

Related U.S. Application Data
(60) Provisional application No. 63/718,187, filed on Nov. 8, 2024.

(51) Int. Cl. G06F 16/332; G06F 16/31

(52) U.S. Cl. CPC G06F 16/3328; G06F 16/316

(57) ABSTRACT

A computer-implemented method may include (i) identifying graph data that includes a plurality of vertices connected by a plurality of edges, (ii) storing at least a portion of the graph data in a key-value store, (iii) receiving a query for the graph data, (iv) retrieving the graph data via the key-value store, and (v) returning the retrieved graph data in response to the query. Various other methods, systems, and computer-readable media are also disclosed.

### CROSS REFERENCE TO RELATED APPLICATION

This application claims the benefit of U.S. Provisional Application No. 63/718,187, filed 8 Nov. 2024, the disclosure of which is incorporated, in its entirety, by this reference.

### BACKGROUND

Graphs composed of vertices or nodes connected by edges are useful for visualizing and storing many types of data, from users on social media sites to game information, media information, and other types of data. Very large graphs, in the range of millions of vertices, may be time- and resource-intensive to query due to their large size and the drawbacks of graphs as a data format.

### SUMMARY

As will be described in greater detail below, the present disclosure describes methods and systems for efficiently querying graphs by storing graph data in a key-value store.

In one example, a computer-implemented method for graph abstraction may include identifying graph data that includes a plurality of vertices connected by a plurality of edges, storing at least a portion of the graph data in a key-value store, receiving a query for the graph data, retrieving the graph data via the key-value store, and returning the retrieved graph data in response to the query.

In some examples, the graph data may include forward edge indices, reverse edge indices, or temporal indices. In one example, the graph data may include a time-to-live value attached to at least one of an edge or a vertex. In some examples, the graph data may include a plurality of partitions configured such that data is isolated between each partition in the plurality of partitions. In one example, the graph data may include a plurality of partitions configured such that a given vertex or edge may be stored in more than one partition within the plurality of partitions.

In some examples, the computer-implemented method may further include receiving an instruction to modify a specified portion of the graph data, retrieving a pointer to the specified portion of the graph data via the key-value store, and modifying the specified portion of the graph data.

In some examples, editing the specified portion of the graph data may include identifying a vertex to be modified based on the instruction, retrieving a maximum number of allowed edges for the vertex, determining that the instruction does not add an edge to the vertex that exceeds the maximum number of allowed edges.

In some examples, storing at least the portion of the graph data in the key-value store includes storing a record of modifications to the graph data in a time-series database. In some examples, receiving the query for the graph data includes receiving a query for temporal information about the modifications to the graph data, and retrieving the graph data via the key-value store includes retrieving data from the time-series database.

In some aspects, the techniques described herein relate to a system including: at least one physical processor, physical memory including computer-executable instructions that, when executed by the physical processor, cause the physical processor to: identify graph data that includes a plurality of vertices connected by a plurality of edges, store at least a portion of the graph data in a key-value store, receive a query for the graph data, retrieve the graph data via the key-value store, and return the retrieved graph data in response to the query.

In some examples, the above-described method may be encoded as computer-readable instructions on a computer-readable medium. For example, a computer-readable medium may include one or more computer-executable instructions that, when executed by at least one processor of a computing device, may cause the computing device to identify graph data that includes a plurality of vertices connected by a plurality of edges, store at least a portion of the graph data in a key-value store, receive a query for the graph data, retrieve the graph data via the key-value store, and return the retrieved graph data in response to the query.

Features from any of the embodiments described herein may be used in combination with one another in accordance with the general principles described herein. These and other embodiments, features, and advantages will be more fully understood upon reading the following detailed description in conjunction with the accompanying drawings and claims.

### 30BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for efficiently storing graph abstractions.

FIG. 2 is a block diagram of an exemplary system for efficiently storing graph abstractions.

FIG. 3 is a block diagram of an exemplary graph.

FIG. 4 is a block diagram of an exemplary key-value store.

FIG. 5 is a block diagram of an exemplary process for recovering from entropy in stored graph abstractions.

FIG. 6 is a block diagram of an exemplary content distribution ecosystem.

FIG. 7 is a block diagram of an exemplary distribution infrastructure within the content distribution ecosystem shown in FIG. 7.

FIG. 8 is a block diagram of an exemplary content player within the content distribution ecosystem shown in FIG. 7.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to systems and methods for efficiently interacting with data stored in graphs by means of a key-value store. As will be explained in greater detail below, embodiments of the present disclosure may improve the functioning of a computing device by improving the ability of the computing device to store, retrieve, and/or modify data by enabling the computing device to perform these operations more quickly and/or while consuming fewer resources (power, processor cycles, etc.). Additionally, or alternatively, the systems described herein may improve the field of data science by enabling data scientists to interact with data stored in graphs more efficiently.

In some examples, embodiments of this disclosure may provide an ability to (1) serve millions of requests/second with high availability and low millisecond latency, (2) compose graphs based on top of key-value storage by having forward, reverse, and temporal indexes, (3) build graphs with time-to-live attached to nodes and edges, (4) filter data at various levels for nodes, edges, and properties based on equality and range checks while still maintaining low millisecond latencies, (5) order traversal output of edges either lexicographically or based on their mutation time, (6) provide chained traversals that chain the output of a previous stage to the next stage while applying all the filters and ordering, (7) provide innovative pagination that allows users to fetch a part of the graph in each page, composing the entire graph at the end of the multi-page fetch, (8) provide a traversal application programming interface (API) that combines all these elements to power a high-throughput, low latency graph, and/or (9) enforce high data quality using an edge, node, and property schema.

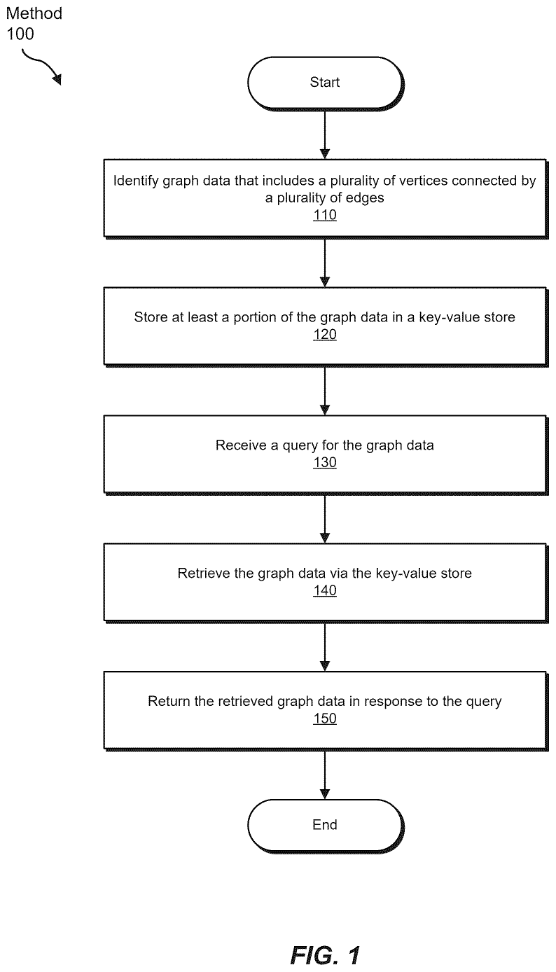

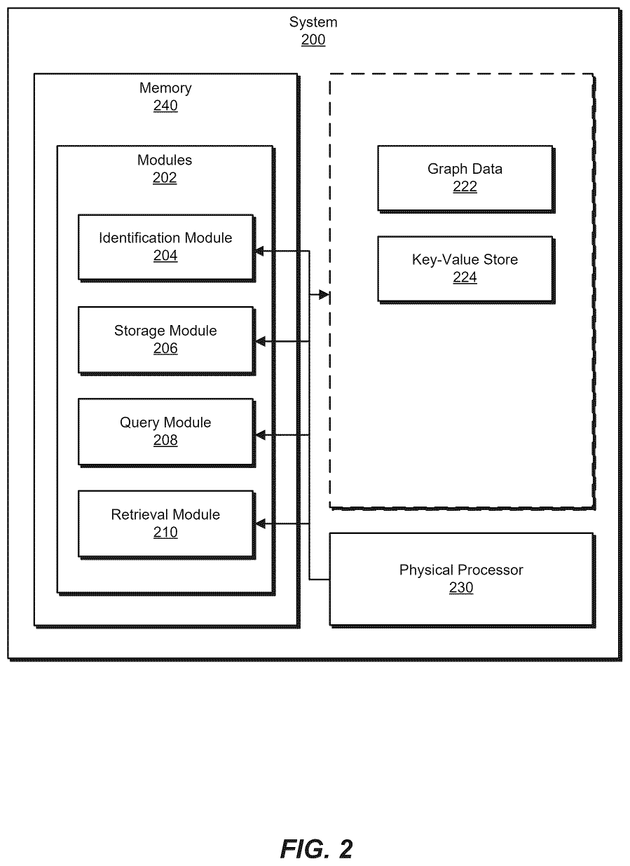

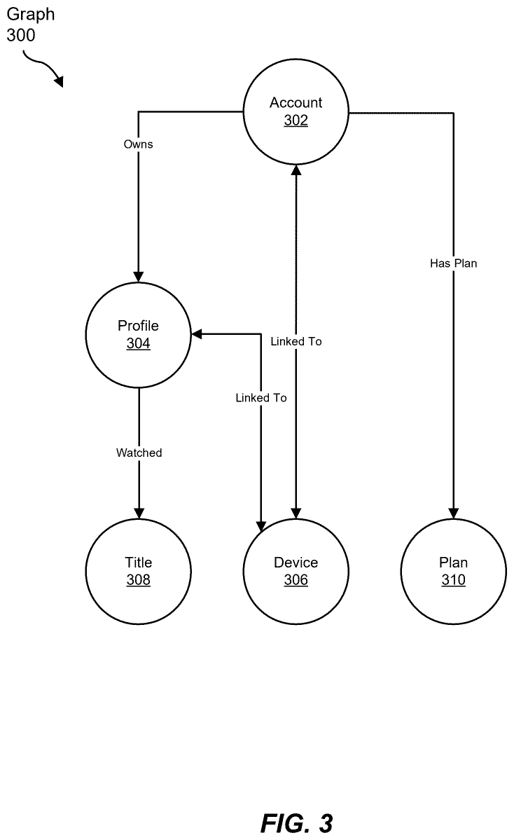

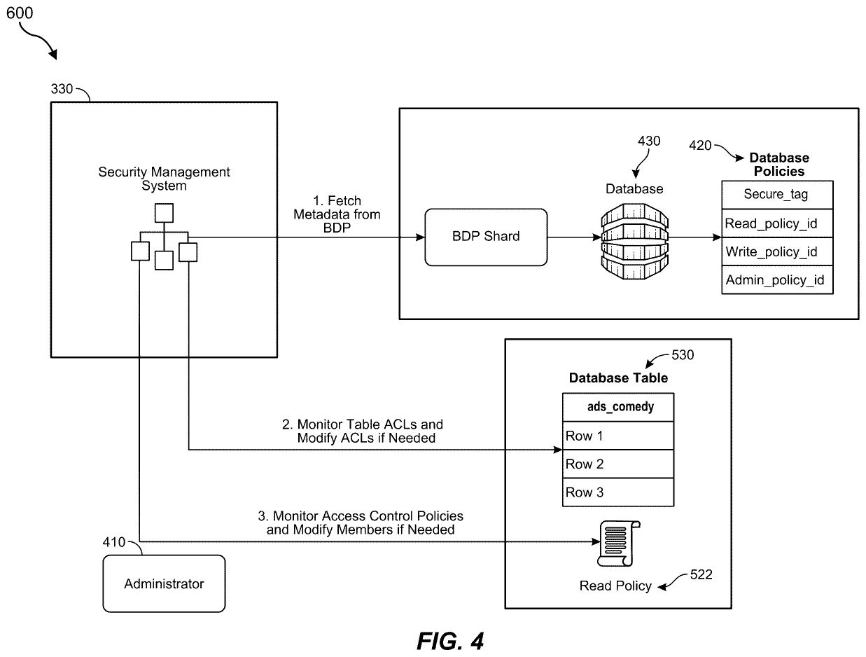

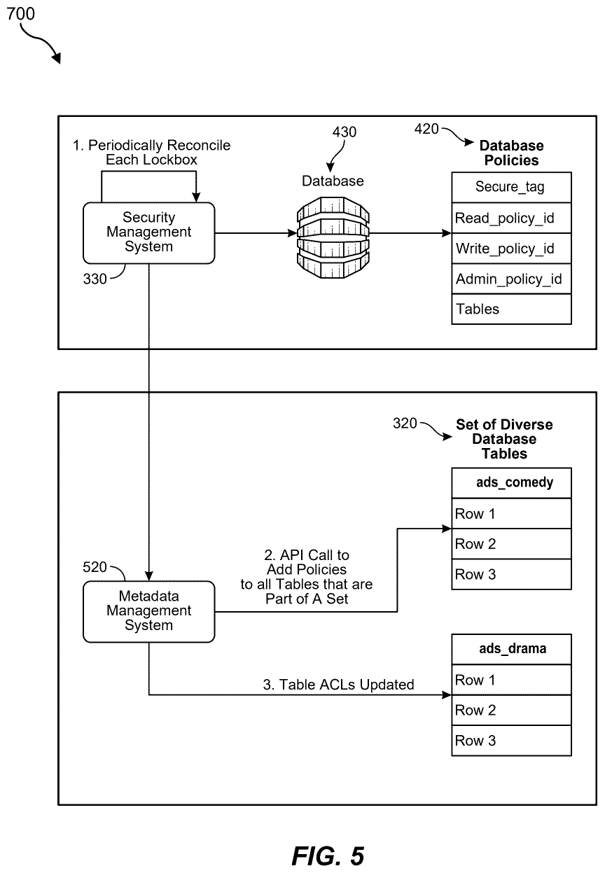

The following will provide, with reference to FIGS. 1-2, detailed descriptions of methods and systems for graph abstraction. Detailed descriptions of exemplary graphs and key-value stores will be provided in connection with FIGS. 3 and 4, respectively. Detailed descriptions of an exemplary method for recovering from data entropy will be provided in connection with FIG. 5.

FIG. 1 is a flow diagram of an exemplary computer-implemented method 100 for graph abstraction. The steps shown in FIG. 1 may be performed by any suitable computer-executable code and/or computing system, including the system(s) illustrated in FIG. 2 (e.g., system 200). In one example, each of the steps shown in FIG. 1 may represent an algorithm whose structure includes and/or is represented by multiple sub-steps, examples of which will be provided in greater detail below.

As illustrated in FIG. 1, at step 110 one or more of the systems described herein may identify graph data that includes a plurality of vertices connected by a plurality of edges. For example, an identification module 204, as part of a set of modules 202 stored within a memory 240 and/or executed by a physical processor 230, may identify graph data 222.

Graph data 222 may represent any type or form of data stored in a graph data structure that is composed of vertices or nodes connected by edges. Edges may be unidirectional, bidirectional, and/or non-directional. Vertices may have various types of properties including values, metadata, etc. In some embodiments, graph data 222 may include very large graphs with millions of vertices and/or edges.

FIG. 3 is an example graph of the type that may be represented by graph data 222. As illustrated in FIG. 3, a graph 300 may include nodes such as account 302, profile 304, device 306, title 308, and/or plan 310 that have various relationships to one another stored in edges, such as seen from, part of, linked to, etc. In one embodiment, graph 300 may represent data for a single user and graph data 222 may store similar data for millions of users.

In one embodiment, a graph may use a property graph model to model its data on top of the key-value (KV) abstraction. In one example, a node may be uniquely identified by its type and a string identifier. It may have a list of properties attached to it, such as a Time-To-Live (TTL) for the node. The node may also have some metadata attached to it as a way for the system to tag it with some relevant information, e.g., the last time this node was modified. In some examples, an edge may be identified by a type and the nodes it connects. Just like the node, the edge may have properties, TTL and/or metadata attached to it. The properties may be one of a variety of data types (e.g., strings, integers, Booleans, etc.), allowing the service to infer how to filter the properties based on its matching type.

Returning to FIG. 1, at step 120, the systems described herein may store at least a portion of the graph data in a key-value store. For example, storage module 206 may store graph data 222 in a key-value store 224.

Key-value store 224 may generally represent any type or form of data structure that stores data in key-value pairs. In some examples, key-value store 224 may store metadata associated with key-value pairs. For example, as illustrated in FIG. 4, a key-value store 400 may store multiple records that each contain a set of items that include a key-value pair and associated metadata. In some examples, an item may have a key but no value or a value but no key. In one embodiment, the data stored in key-value store 400 may be graph data such as the data of graph 300.

Returning to FIG. 1, at step 130, the systems described herein may receive a query for the graph data. For example, query module 208 may receive a query for graph data 222.

The systems described herein may receive a variety of types of queries. In some examples, the systems described herein may receive a query to traverse the graph data; that is, to return a list of vertices and/or edges connected to one or more specified vertices and/or edges. For example, the systems described herein may receive a query to return all data associated with a user, which may involve traversing nodes linked to the node representing the user such as device, location, etc. In one example, a query may be in the format of, given a list of start nodes and traversal criteria, display the latest N connections. In another example, a query may be in the format of, given a list of start nodes and traversal criteria, show the evolution of the graph over a specified time interval.

At step 140, the systems described herein may retrieve the graph data via the key-value store. For example, retrieval module 210 may retrieve graph data 222 via KV store 224.

In some embodiments, the systems described herein may retrieve the graph data directly from the KV store (e.g., the data may be stored in the KV store). Additionally, or alternatively, the systems described herein may retrieve the graph data using a reference stored in the KV store (e.g., the KV store may store a pointer to the graph data). In some embodiments, the systems described herein may retrieve the graph data efficiently by using metadata about the graph data stored in the KV store (e.g., storage location data, timestamp data, etc.).

At step 150, the systems described herein may return the retrieved graph data in response to the query. For example, query module 208 may return some or all of graph data 222.

In some examples, the systems described herein may return some of the data immediately and may pause the query to await further instructions. For example, the systems described herein may paginate the results and may return a first page and not retrieve subsequent pages until requested.

The systems described herein may store graph data for a variety of types and scales of graphs. In some embodiments, the systems described herein may enable users to create multiple graph datasets via namespaces. Each namespace may be a collection of nodes and edges and may have tunable configuration such as retention (e.g., enforced via a namespace-level TTL), physical storage (e.g., in which KV cluster is this data stored?), and/or traversal configuration (e.g., how many edges to limit in traversals, the format of the graph schema, etc.). As with other abstractions, the infrastructure may be sharded with the options to pick and choose environments and regions. The underlying storages may be shared or isolated with the required access controls, all controlled by the service control plane.

In one embodiment, the systems described herein may be configured such that users must assign an explicit schema to their namespaces ahead of time. The schema is the blueprint of how the nodes, edges and properties interact with each other. For example, as illustrated in FIG. 3, a scheme forgraph 300 may specify that the relationship between an account 20 relationship, while the relationship between an account node and a device node such as device 306 is a bidirectional “linked to” relationship. In one embodiment, this may be driven by a namespace configuration called edge mappings. The edge mapping may specify a fromNodeType, a toNodeType, and an edgeType for the type of edge between those two nodes, as well as a directionality, such as unidirectional or bidirectional. In some examples, the edge mapping may also specify one or more properties and the data type of those properties, such as a deviceType that is a string, a device registration timestamp that is a timestamp, and so forth.

The systems described herein may use a graph schema for a variety of purposes. For example, the systems described herein may use a graph scheme to improve data quality by rejecting nodes, edges, and/or properties that do not conform to the schema. In some examples, given a starting node and a type of node or an edge, the systems described herein may infer the paths that can be traversed due to knowing what possible directions are available given a start node (e.g., based on the edge mapping) and what possible traversals can be chained together (e.g., from an account to a profile to a household).

In some embodiments, the systems described herein may enable and/or assist with filtering. For example, a property schema may be used to infer the types of properties, what kind of properties can be pre-fetched and the kind of filtering possible (e.g., range filters only make sense for certain data types, etc.). In some examples, the systems described herein may use this information to infer the optimal way to traverse between two specified nodes, for example by including cardinality information of edges for a given edgeType to choose the path that results in the smallest traversal fanout.

In one embodiment, the KV store may store data in distinct namespaces. In some embodiments, each namespace may be viewed as isolated, distributed and highly efficient dataset that contains mapping between an identifier (ID) and sorted set of item keys and values. For example, as illustrated in FIG. 4, KV store 400 may have a set of records with identifiers such as R17, R9, R0, etc., that map to a sorted set of keys and values. In some embodiments, writes, reads, and deletes for an entire record or predefined set of keys within a record may be extremely efficient. In some examples, this graph abstraction may take full advantage of the underlying KV structure by laying out the data for best write throughput and lowest possible read latencies for the majority of the graph access patterns.

In one embodiment, for every registered node type in in a KV store, the systems described herein may allocate a dedicated KV namespace that stores all the nodes of the registered type as well as properties associated with every such node. The below table is an example of how this data may be stored:

| KV | | KV Item | KV Item |
|---|---|---|---|
| Namespace | KV Id | key | Value |
| <node_type> | <node_id> | EMPTY | EMPTY |
| | (e.g., id1) | <property | <serialized |
| | | name> | property value> |
| | | (e.g., isActivated) | (e.g., true) |
| | | createdAt | 2022 Oct. 12 |
| | id2 | EMPTY | EMPTY |

Since the systems described herein may co-locate properties with the node itself, the systems described herein need to be able to properly represent the fact of a node's existence decoupled from the presence of its properties. Otherwise the storage will not allow for persistence of a node without a single property. One typical expected usage pattern is extraction of nodes with all their associated properties. In one embodiment, this results in the systems described herein making a single read to the KV abstraction and retrieving the entire KV record in low tens of milliseconds. In case a caller requests specific property keys with the node, the selection of properties is passed down to KV making it an even more efficient lookup.

In some examples, from a data modeling standpoint the edge object may have much more variety than the node. There are couple of dimensions that the systems described herein have to take into account: edges can be queried based on directionality, edges are defined not only by their own type but by the outgoing and incoming node types, and edges have properties.

Storage of nodes and their properties may be very easy to reconcile with the two-layered structure of the KV Abstraction. However, given all of the edge dimensions above and the fact that the systems described herein may optimize for retrieval of all edges originating at a certain node, in some embodiments the systems described herein may encompass every dimension of an edge in its own KV namespace. For every edge type, the systems described herein may allocate one KV namespace for edge connections in direct form (e.g., node A connects to node B), or OUT direction, edge connections in reverse form (e.g., node B connects to node A), or IN direction, and/or edge properties. The below table is an example of how edges may be indexed for IN and OUT directions:

| KV | | KV Item | KV Item |
|---|---|---|---|
| Namespace | KV Id | key | Value |
| <from_node_type>_{—} | <from_node_id> | <to_node_id> | EMPTY |
| <edge_type>_{—} | (e.g., o_account1) | (e.g., device1) | |
| <to_node_type>_{—} | | device2 | EMPTY |
| <direction> | account2 | device3 | EMPTY |
| | | device4 | EMPTY |

The below table is an example of how the edge properties may appear when persisted into their own KV namespace:

| KV | | KV Item | KV Item |
|---|---|---|---|
| Namespace | KV Id | key | Value |
| <from_{—} | <from_{—} | <property | true |
| node_type>_{—} | node_id>_{—} | key> | |
| <edge_type>_{—} | <to_node_id> | (e.g., isPermanent) | |
| <to_node_type>_{—} | (e.g., account1_{—} | isActive | false |
| properties | device1) | | |
| | account1_{—} | isPermanent | false |
| | device2 | isActive | true |

In some examples, this storage layout may be highly efficient for fast retrieval of all the edges that originate at a certain node. However, the systems described herein may retrieve all properties of every edge beyond the first node because properties are indexed by specific edges and stored separately. This is an trade-off enables the systems designed herein to store edges originating in the nodes with higher degree (e.g., hundreds of thousands of edges). As used herein, the term “forward edge indices” refers to data structures or records that index edges based on their originating node, such that each forward edge index enables efficient retrieval of all edges that emanate from a given node to one or more destination nodes. Conversely, the term “reverse edge indices” refers to data structures or records that index edges based on their terminating node, thereby enabling efficient retrieval of all edges that terminate at a given node from one or more source nodes. In some embodiments, forward edge indices may be implemented by associating each node with a list or set of outgoing edges, while reverse edge indices may be implemented by associating each node with a list or set of incoming edges. This dual-indexing approach facilitates rapid traversal and query operations in both directions along the edges of the graph.

When persisting a node, the systems described herein may upsert (i.e., update a record if a record exists or insert a new record if a record does not exist) all KV Items related to a graph node into KV namespace related to the node type. In some embodiments, the KV abstraction may guarantee atomicity of writes for all the items within the same record. Persisting an edge may be a more involved process that is strictly eventually consistent because it involves persistence into multiple KV namespaces. When persisting an edge the systems described herein first upsert the properties and after that index the edge for OUT and IN direction. In some embodiments, when modifying a specified portion of the graph data, the systems described herein may enforce constraints on the number of edges associated with a given vertex. For example, upon receiving an instruction to modify a vertex—such as adding a new edge—the system may first identify the vertex to be modified and retrieve a configuration parameter or schema value specifying the maximum number of allowed edges for that vertex. The system may then determine whether the requested modification would result in the vertex exceeding this maximum edge count. If the instruction would cause the vertex to surpass the allowed number of edges, the system may reject the modification or return an error, thereby ensuring that the graph data remains consistent with predefined schema constraints. This approach helps maintain data integrity and prevents the creation of vertices with an excessive number of connections, which could otherwise impact performance or violate application-specific rules.

In one embodiment, for both nodes and edges, all operations may be retryable and/or idempotent based on the user's idempotency token. In some examples, every persistence operation may be an upsert; the systems described herein may not perform read-before-write prioritizing throughput of the data storage operations. This upsert approach to writes may enable the caller to update and append individual properties to the node and the edge without knowing the full state of the properties for a specific graph object.

In the above embodiments, reading a single node with all its properties may be a simple retrieval of an entire record from KV. Reading all nodes connected to the provided node with provided edge type is also a read of an entire record from KV. Retrieving all properties for every edge is also a record read in KV. Given that every record read from KV is a low latency operation, this allows the systems described herein to perform efficiently in terms of point reads.

During graph traversals it is important to be able to fetch only a certain amount of edges and continue the fetch process on demand, especially when implementing something like pagination or paced consumption of traversal results. In those cases it is important to be able to scan the dataset efficiently and resume consumption from an arbitrary position in the dataset. As the data layout above shows, the systems described herein consume data most effectively when the systems described herein perform a full record consumption from KV. In cases when the systems described herein need to perform a range scan, the systems described herein may scan only the range within the KV record, relying on the fact that the sorted nature of data allows the system to continue the scan by just temporarily storing the last item key of the node from the previous scan. In some examples, the systems described herein may then construct an open-ended lexicographical range of data the system is attempting to locate by specifying the last item key as a starting point of the range.

Many graph use-cases may require the ability to know what edges originating from a provided starting node in a graph were established most recently (e.g., social networks, security, etc.). In order to support this, the systems described herein fetch an entire KV record and sort retrieved edges in-memory by the last modification timestamp provided by KV abstraction.

In some embodiments, the KV store may provide an optional integration with a cache that is heavily utilized by the graph abstraction. In one embodiment, the integration may be performed using the KV namespace configuration. In some embodiments, the KV store may provide a read-through cache, meaning that first read will hit the underlying storage (e.g., a database) but will be cached afterwards. KV may cache both layers of its structure: entire record and every individual item in the record. In some embodiments, KV may invalidate the cache every time data is deleted. In some embodiments, storing the graph data in the KV store may involve storing a record of modifications to the graph data in a time-series database. For example, each time a node or edge is created, updated, or deleted, the system may generate a corresponding event or mutation record that is written to a time-series database in addition to the primary KV store. This time-series database may maintain a chronological log of all changes made to the graph data, including the type of modification, the affected node or edge, and the timestamp of the event. By maintaining this historical record, the system enables efficient support fortemporal queries, auditing, and reconstruction of the graph's state at any given point in time. This approach also facilitates advanced features such as time-based traversals, rollback operations, and analysis of the evolution of the graph structure over time.

In some examples, the systems described herein may perform running graph traversals against a temporal snapshot of the graph data that consists of nodes and edges that have been modified within a specific time interval. For example, the systems described herein may, for all nodes, edges and their properties in the output graph, retrieve the mutation event log along with their timestamps. Additionally or alternatively, the systems described herein may retrieve the latest state of the output graph in the specified time interval by resolving to the final state of nodes and edges. To perform such traversals, the systems described herein may be configured to both store temporal mutations and also perform range reads based on a time interval to retrieve events, matching edges and nodes encountered in the traversal. For these reasons, the systems described herein may be configured to use a TimeSeries abstraction.

For each graph namespace, the systems described herein may provision a fixed set of TimeSeries namespaces that index edges, properties, and nodes in the same way as the real-time index. The event time in TimeSeries supports millisecond resolution. However, to optimize the cost of storing high-throughput mutations, the systems described herein may be configured to reduce the event time resolution to minutes. This approach lets the systems described herein leverage the idempotency nature of event records in TimeSeries leading the system to store only the latest mutated state of an edge or node in each minute.

In some embodiments, each write to the graph abstraction may result in the persistence of data across multiple namespaces in the underlying store. To handle high-throughput mutations, the systems described herein may parallelize writes to all the namespaces. Without a rollback mechanism, one or more write failures can lead to an inconsistent state in the graph, introducing entropy. To address this issue, the graph abstraction may incorporate an implicit retry mechanism, as illustrated in FIG. 5.

A KV store 500 may interact with a main stack 502 that may send failed writes to a persistent queue, where they are consumed by a background process and retried on the service. Since the underlying store guarantees idempotency, the systems described herein may simply retry the graph mutation request rather than the individual underlying datastore requests. If the retries are exhausted, the systems described herein may send the requests to a dead-letter queue (DLQ) 504 for ad-hoc analysis.

To effectively manage entropy repair, the systems described herein may use a distributed data store 506 that is configured to ingest and process streaming data as our persistent queue solution. Each graph namespace may be assigned a dedicated distributed data store topic to ensure isolation and efficient processing. The distributed data store consumer process may operate in a separate event stack 508, where failed requests are retried through the ProcessEvents endpoint. Additionally, the systems described herein may provision distributed data store topics for each graph namespace to serve as DLQs, facilitating targeted analysis of exhausted retries.

The systems described herein may enable a variety of types of graph traversals to be carried out efficiently. For example, the systems described herein may facilitate node traversals, edge traversals, direction traversals, and/or chained traversals. In some examples, the systems described herein may enable a caller to order traversals by time and/or other properties and/or filter results by properties (e.g., property value is equal to a specified value, property value is within a specified range, etc.). In some examples, the systems described herein may limit the amount of data fetched within a single traversal and/or paginate results to avoid consuming excess resources with a single query.

In some examples, the systems described herein may facilitate “time travel” traversals that enable users to execute traversals against a temporal snapshot of the graph, i.e., graph mutations that occurred in a specified time interval in the past. In one example, a request may include the traversal query, time interval, and the output mode. The output mode may dictate how mutation events involving edges and nodes in the traversal should be consolidated or resolved. For example, in a snapshot mode, if an edge has several mutations occurring in a specified time interval, the systems described herein may pick the latest one along with its timestamp to return to the user. In a mutation history mode, instead of consolidating all mutations, the systems described herein may return all of them along with their timestamps. If the user is interested in a specific time-based ordering for the mutation, they can specify it in the traversal order.

As described above, the systems described herein may enable efficient retrieval of graph data for large graphs that are accessed frequently (e.g., millions of times a minute) by using a KV abstraction to store the graph data, references to the graph data, and/or metadata about the graph data. In some embodiments, a time series abstraction may facilitate time-based queries such as “which nodes have changed in the last hour?” or “what are the newest nodes connected to this node?” In one embodiment, a graph scheme may enforce certain data types on certain properties, reducing the chances of errors. In some embodiments, partitioning the graph such that data is isolated between partitions but any given edge or vertex can be stored in more than one partition may further reduce the chances of errors, improve the efficiency of queries, and/or provide additional benefits.

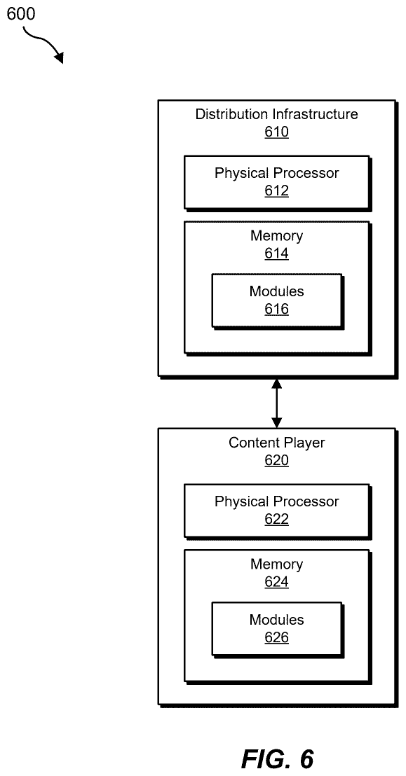

FIG. 6 is a block diagram of a content distribution ecosystem 600 that includes a distribution infrastructure 610 in communication with a content player 620. In some embodiments, distribution infrastructure 610 may be configured to encode data and to transfer the encoded data to content player 620 via data packets. Content player 620 may be configured to receive the encoded data via distribution infrastructure 610 and to decode the data for playback to a user. The data provided by distribution infrastructure 610 may include audio, video, text, images, animations, interactive content, haptic data, virtual or augmented reality data, location data, gaming data, or any other type of data that may be provided via streaming.

Distribution infrastructure 610 generally represents any services, hardware, software, or other infrastructure components configured to deliver content to end users. For example, distribution infrastructure 610 may include content aggregation systems, media transcoding and packaging services, network components (e.g., network adapters), and/or a variety of other types of hardware and software. Distribution infrastructure 610 may be implemented as a highly complex distribution system, a single media server or device, or anything in between. In some examples, regardless of size or complexity, distribution infrastructure 610 may include at least one physical processor 612 and at least one memory device 614. One or more modules 616 may be stored or loaded into memory 614 to enable adaptive streaming, as discussed herein.

Content player 620 generally represents any type or form of device or system capable of playing audio and/or video content that has been provided over distribution infrastructure 610. Examples of content player 620 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 610, content player 620 may include a physical processor 622, memory 624, and one or more modules 626. Some or all of the adaptive streaming processes described herein may be performed or enabled by modules 626, and in some examples, modules 616 of distribution infrastructure 610 may coordinate with modules 626 of content player 620 to provide adaptive streaming of multimedia content.

In certain embodiments, one or more of modules 616 and/or 626 in FIG. 6 may represent one or more software applications or programs that, when executed by a computing device, may cause the computing device to perform one or more tasks. For example, and as will be described in greater detail below, one or more of modules 616 and 626 may represent modules stored and configured to run on one or more general-purpose computing devices. One or more of modules 616 and 626 in FIG. 6 may also represent all or portions of one or more special-purpose computers configured to perform one or more tasks.

Physical processors 612 and 622 generally represent any type or form of hardware-implemented processing unit capable of interpreting and/or executing computer-readable instructions. In one example, physical processors 612 and 622 may access and/or modify one or more of modules 616 and 626, respectively. Additionally or alternatively, physical processors 612 and 622 may execute one or more of modules 616 and 626 to facilitate adaptive streaming of multimedia content. Examples of physical processors 612 and 622 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 614 and 624 generally represent any type or form of volatile or non-volatile storage device or medium capable of storing data and/or computer-readable instructions. In one example, memory 614 and/or 624 may store, load, and/or maintain one or more of modules 616 and 626. Examples of memory 614 and/or 624 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

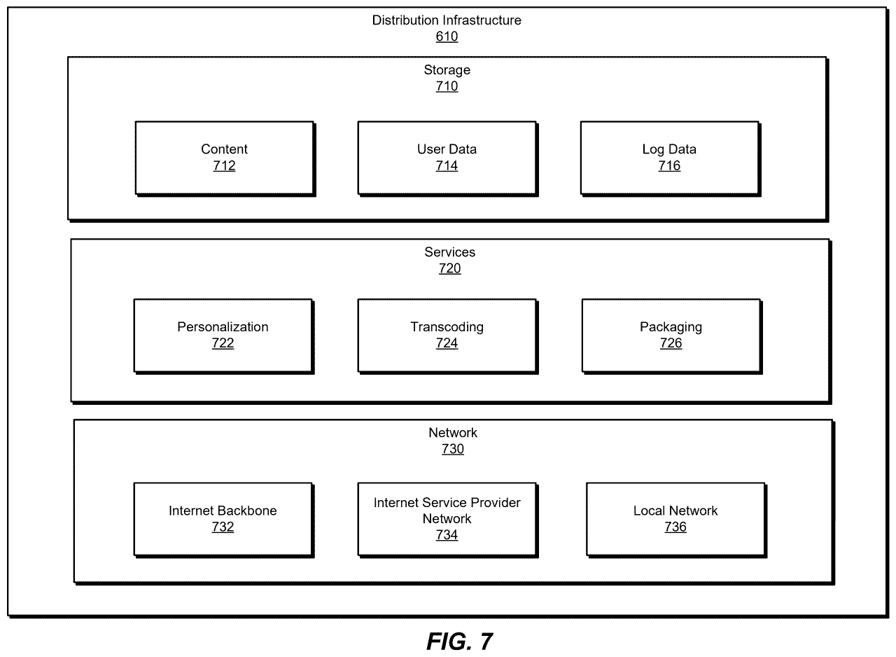

FIG. 7 is a block diagram of exemplary components of content distribution infrastructure 610 according to certain embodiments. Distribution infrastructure 610 may include storage 710, services 720, and a network 730. Storage 710 generally represents any device, set of devices, and/or systems capable of storing content for delivery to end users. Storage 710 may include a central repository with devices capable of storing terabytes or petabytes of data and/or may include distributed storage systems (e.g., appliances that mirror or cache content at Internet interconnect locations to provide faster access to the mirrored content within certain regions). Storage 710 may also be configured in any other suitable manner.

As shown, storage 710 may store, among other items, content 712, user data 714, and/or log data 716. Content 712 may include television shows, movies, video games, user-generated content, and/or any other suitable type or form of content. User data 714 may include personally identifiable information (PII), payment information, preference settings, language and accessibility settings, and/or any other information associated with a particular user or content player. Log data 716 may include viewing history information, network throughput information, and/or any other metrics associated with a user's connection to or interactions with distribution infrastructure 610.

Services 720 may include personalization services 722, transcoding services 724, and/or packaging services 726. Personalization services 722 may personalize recommendations, content streams, and/or other aspects of a user's experience with distribution infrastructure 610. Encoding services, such as transcoding services 724, may compress media at different bitrates which may enable real-time switching between different encodings. Packaging services 726 may package encoded video before deploying it to a delivery network, such as network 730, for streaming.

Network 730 generally represents any medium or architecture capable of facilitating communication or data transfer. Network 730 may facilitate communication or data transfer via transport protocols using wireless and/or wired connections. Examples of network 730 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 7, network 730 may include an Internet backbone 732, an internet service provider 734, and/or a local network 736.

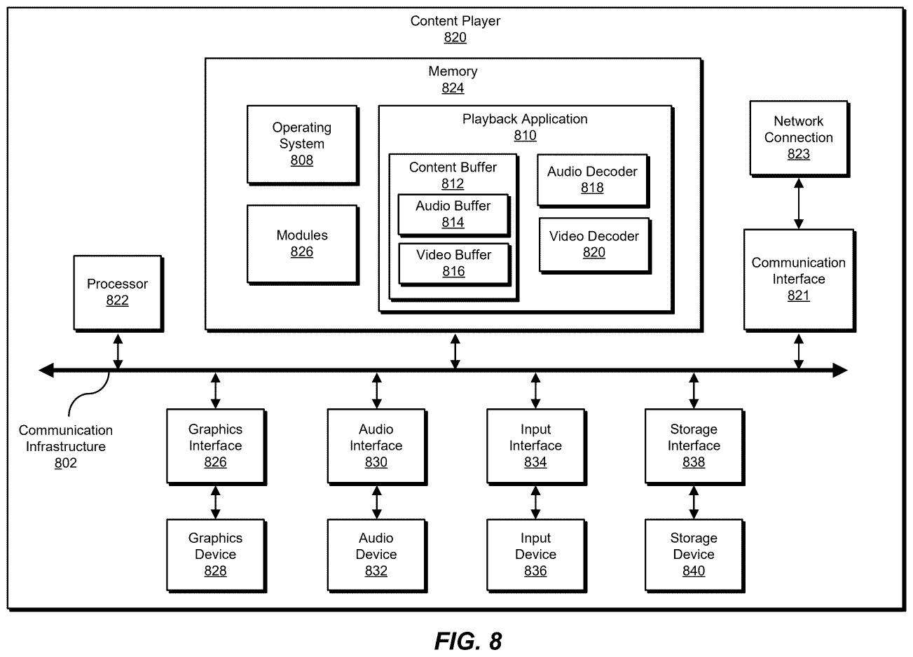

FIG. 8 is a block diagram of an exemplary implementation of content player 620 of FIG. 6. Content player 620 generally represents any type or form of computing device capable of reading computer-executable instructions. Content player 620 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 8, in addition to processor 822 and memory 824, content player 620 may include a communication infrastructure 802 and a communication interface 821 coupled to a network connection 823. Content player 620 may also include a graphics interface 826 coupled to a graphics device 828, an audio interface 830 coupled to an audio device 832, an input interface 834 coupled to an input device 836, and a storage interface 838 coupled to a storage device 840.

Communication infrastructure 802 generally represents any type or form of infrastructure capable of facilitating communication between one or more components of a computing device. Examples of communication infrastructure 802 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 824 generally represents any type or form of volatile or non-volatile storage device or medium capable of storing data and/or other computer-readable instructions. In some examples, memory 824 may store and/or load an operating system 808 for execution by processor 822. In one example, operating system 808 may include and/or represent software that manages computer hardware and software resources and/or provides common services to computer programs and/or applications on content player 620.

Operating system 808 may perform various system management functions, such as managing hardware components (e.g., graphics interface 826, audio interface 830, input interface 834, and/or storage interface 838). Operating system 808 may also process memory management models for playback application 810. The modules of playback application 810 may include, for example, a content buffer 812, an audio decoder 818, and a video decoder 820.

Playback application 810 may be configured to retrieve digital content via communication interface 821 and play the digital content through graphics interface 826. A video decoder 820 may read units of video data from audio buffer 814 and/or video buffer 816 and the fixed span of playback time. Reading a unit of video data from video buffer 816 may effectively de-queue the unit of video data from video buffer 816. The sequence of video frames may then be rendered by graphics interface 826 and transmitted to graphics device 828 to be displayed to a user.

In situations where the bandwidth of distribution infrastructure 610 is limited and/or variable, playback application 810 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 620 may also include a storage device 840 coupled to communication infrastructure 802 via a storage interface 838. Storage device 840 generally represent any type or form of storage device or medium capable of storing data and/or other computer-readable instructions. For example, storage device 840 may be a magnetic disk drive, a solid-state drive, an optical disk drive, a flash drive, or the like. Storage interface 838 generally represents any type or form of interface or device for transferring data between storage device 840 and other components of content player 620.

Many other devices or subsystems may be included in or connected to content player 620. Conversely, one or more of the components and devices illustrated in FIG. 8 need not be present to practice the embodiments described and/or illustrated herein. The devices and subsystems referenced above may also be interconnected in different ways from that shown in FIG. 8. Content player 620 may also employ any number of software, firmware, and/or hardware configurations.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive an image sequence to be transformed, transform the image sequence to create novel flat-lit images, output a result of the transformation to a diffusion-based relighting model, use the result of the transformation to relight the image sequence, and store the result of the transformation to create a new video. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying graph data that comprises a plurality of vertices connected by a plurality of edges;
storing at least a portion of the graph data in a key-value store;
receiving a query for the graph data;
retrieving the graph data via the key-value store; and
returning the retrieved graph data in response to the query.

2. The computer-implemented method of claim 1, wherein the graph data comprises:
forward edge indices;
reverse edge indices; or
temporal indices.

3. The computer-implemented method of claim 1, wherein the graph data comprises a time-to-live value attached to at least one of an edge or a vertex.

4. The computer-implemented method of claim 1, wherein the graph data comprises a plurality of partitions configured such that data is isolated between each partition in the plurality of partitions.

5. The computer-implemented method of claim 1, wherein the graph data comprises a plurality of partitions configured such that a given vertex or edge may be stored in more than one partition within the plurality of partitions.

6. The computer-implemented method of claim 1, further comprising:
receiving an instruction to modify a specified portion of the graph data;
retrieving a pointer the specified portion of the graph data via the key-value store; and
modifying the specified portion of the graph data.

7. The computer-implemented method of claim 6, wherein modifying the specified portion of the graph data comprises:
identifying a vertex to be modified based on the instruction;
retrieving a maximum number of allowed edges for the vertex; and
determining that the instruction does not add an edge to the vertex that exceeds the maximum number of allowed edges.

8. The computer-implemented method of claim 1, wherein storing at least the portion of the graph data in the key-value store comprises storing a record of modifications to the graph data in a time-series database.

9. The computer-implemented method of claim 8, wherein:
receiving the query for the graph data comprises receiving a query for temporal information about the modifications to the graph data; and
retrieving the graph data via the key-value store comprises retrieving data from the time-series database.

10. A system comprising:
at least one physical processor; and
physical memory comprising computer-executable instructions that, when executed by the physical processor, cause the physical processor to:
identify graph data that comprises a plurality of vertices connected by a plurality of edges;
store at least a portion of the graph data in a key-value store;
receive a query for the graph data;
retrieve the graph data via the key-value store; and
return the retrieved graph data in response to the query.

11. The system of claim 10, wherein the graph data comprises:
forward edge indices;
reverse edge indices; or
temporal indices.

12. The system of claim 10, wherein the graph data comprises a time-to-live value attached to at least one of an edge or a vertex.

13. The system of claim 10, wherein the graph data comprises a plurality of partitions configured such that data is isolated between each partition in the plurality of partitions.

14. The system of claim 10, wherein the graph data comprises a plurality of partitions configured such that a given vertex or edge may be stored in more than one partition within the plurality of partitions.

15. The system of claim 10, wherein the computer-executable instructions further cause the physical processor to:
receive an instruction to modify a specified portion of the graph data;
retrieve a pointer the specified portion of the graph data via the key-value store; and
modify the specified portion of the graph data.

16. The system of claim 15, wherein editing the specified portion of the graph data comprises:
identifying a vertex to be modified based on the instruction;
retrieving a maximum number of allowed edges for the vertex; and
determining that the instruction does not add an edge to the vertex that exceeds the maximum number of allowed edges.

17. The system of claim 10, wherein storing at least the portion of the graph data in the key-value store comprises storing a record of modifications to the graph data in a time-series database.

18. The system of claim 17, wherein:
receiving the query for the graph data comprises receiving a query for temporal information about the modifications to the graph data; and
retrieving the graph data via the key-value store comprises retrieving data from the time-series database.

19. A non-transitory computer-readable medium comprising one or more computer-executable instructions that, when executed by at least one processor of a computing device, cause the computing device to:
identify graph data that comprises a plurality of vertices connected by a plurality of edges;
store at least a portion of the graph data in a key-value store;
receive a query for the graph data;
retrieve the graph data via the key-value store; and
return the retrieved graph data in response to the query.

20. The non-transitory computer-readable medium of claim 19, wherein the graph data comprises:
forward edge indices;
reverse edge indices; or
temporal indices.
